(19) United States
(12) Patent Application Publication
(10) Pub. No.: US 2013/0166945 A1
(43) Pub. Date: Jun. 27, 2013

(54) STORAGE DEVICE

(71) Applicants: Masahito Nakao, Osaka (JP); Motoshi Ito, Osaka (JP)

(72) Inventors: Masahito Nakao, Osaka (JP); Motoshi Ito, Osaka (JP)

(73) Assignee: PANASONIC CORPORATION, Osaka (JP)

(21) Appl. No.: 13/820,192

(22) PCT Filed: Feb. 2, 2012
(86) PCT No.: PCT/JP2012/000695

§ 371 Date: Mar. 1, 2013

(30) Foreign Application Priority Data
Feb. 4, 2011 (JP) 2011-022371

(51) Int. Cl. G06F 11/20

(52) U.S. Cl. CPC G06F 11/2094
USPC 714/6.21

(57) ABSTRACT

A storage device according to the present invention constructs a RAID structure using a plurality of detachable recording mediums. When a first drive device fails to reproduce data from a recording medium, a transport device transports the recording medium to a second drive device different from the first drive device which failed to reproduce the data, and the second drive device attempts to reproduce the data from the recording medium, the data reproduction from which failed. Owing to this, even when faults of a number exceeding the number of faults correctable by the RAID structure occur, the probability that the data is recovered can be improved.

### TECHNICAL FIELD

The present invention relates to a storage device, and specifically to a disc array device using a plurality of recording mediums.

### BACKGROUND ART

An example of high-performance storage device is a disc array device. The disc array device performs parallel processes by use of a plurality of drive devices to provide a high level of performance of a disc array system. As a drive device, a hard disc drive device is generally used. However, the hard disc drive device malfunctions relatively easily. Therefore, RAID (Redundant Arrays of Inexpensive Disk) is constructed to provide redundancy, so that fault tolerance (high reliability) is provided.

Recently, data capacity to be stored is significantly increased. Therefore, in a disc array device using hard disc drive devices, the number of hard disc drive devices used is increased so that the disc array device has a larger capacity. In this case, in proportion to the number of the hard disc drive devices, the power consumption is significantly increased. Such an increase of power consumption is not desirable for environmental preservation of the earth. For this reason, a disc array device of low power consumption is desired. As one of such disc array devices, a disc array device using optical disc drive devices is now a target of attention.

The disc array device using optical disc drive devices can also have fault tolerance (high reliability) by having a RAID structure like in the case of the above-described disc array device using hard disc drive devices (see, for example, Patent Document 1).

FIG. 1 shows an example of structure of a disc array device using optical disc drive devices. A disc array device 1001 includes a control device 1002, a plurality of recording mediums 1003, a plurality of drive devices 1004, a plurality of accommodation devices 1005, and a plurality of transport devices 1006.

The control device 1002 performs a transfer process between an external processing device (not shown) and any of the drive devices 1004 in compliance with a request from the external processing device.

The disc array device 1001 includes n+m number of transport devices 1006. Even when a part of the transport devices 1006 malfunctions, the transport devices 1006 which do not malfunction are used so that the recording medium 1003 can be transported to the corresponding drive device 1004.

Regarding the recording mediums 1003, m+n number of recording mediums 1003 form a parity group. User data is recorded on m number of recording mediums 1003, and parity data is recorded on n number of recording mediums 1003. The disc array device 1001 includes m+n number of drive devices 1004. The m+n number of recording mediums 1003 forming a parity group are mounted on the m+n number of drive devices 1004. In the disc array device 1001, even when data cannot be reproduced from n or smaller number of recording mediums 1003 among the m+n number of recording mediums 1003 forming a parity group, the data which cannot be reproduced can be recovered based on data read from the remaining recording mediums 1003.

### CITATION LIST

### Patent Literature

Patent Document 1: Japanese Laid-Open Patent Publication No. 10-254639

### SUMMARY OF INVENTION

### Technical Problem

However, the above-described disc array device is structured with no consideration on what measure is to be taken when faults of a number exceeding the number of faults correctable by the RAID structure occur to the recording mediums. Therefore, there is a problem that when faults of a number exceeding the correctable number of faults occur to the recording mediums, data cannot be recovered.

Now, an example of case where data cannot be recovered by a parity function will be described with reference to FIG. 2 and Table 1. Table 1 shows whether or not data can be recovered by the disc array device shown in FIG. 2. In FIG. 2, a recording medium 2003-a-1 is mounted on a drive device 2004-a-1, a recording medium 2003-b-1 is mounted on a drive device 2004-b-1, and a recording medium 2003-c-1 is mounted on a drive device 2004-c-1. On one of the plurality of recording mediums, parity data is recorded. Thus, when a fault occurs to one or less recording medium, data can be recovered.

TABLE 1

| | DRIVE DEVICE | | | | | | |
|---|---|---|---|---|---|---|---|
| | | | | | | | 2004-a-1 |
| RECORDING | | | | 2004-a-1 | 2004-a-1 | 2004-b-1 | 2004-b-1 |
| MEDIUM | 2004-a-1 | 2004-b-1 | 2004-c-1 | 2004-b-1 | 2004-c-1 | 2004-c-1 | 2004-c-1 |
| 2003-a-1 | ◯ | ◯ | ◯ | X | X | X | X |
| 2003-b-1 | ◯ | ◯ | ◯ | X | X | X | X |
| 2003-c-1 | ◯ | ◯ | ◯ | X | X | X | X |
| 2003-a-1 | X | X | X | X | X | X | X |
| 2003-b-1 | | | | | | | |
| 2003-a-1 | X | X | X | X | X | X | X |
| 2003-c-1 | | | | | | | |
| 2003-a-1 | X | X | X | X | X | X | X |
| 2003-b-1 | | | | | | | |
| 2003-c-1 | | | | | | | |

Conceivable reasons why data cannot be reproduced from a recording medium are that a fault occurs to the recording medium itself and that a fault occurs to the drive device having the recording medium mounted thereon. In the disc array device shown in FIG. 2, when a fault occurs to one or less recording medium or when a fault occurs to one or less drive device, error correction can be made and thus data can be recovered. In Table 1, a combination of the faulty recording medium and the faulty drive device for which data can be recovered is represented with “◯”, and a combination of the faulty recording mediums and the faulty drive devices for which data cannot be recovered is represented with “X”.

As shown in Table 1, when faults of a number exceeding the correctable number of faults occur to the recording mediums or the drive devices, data cannot be recovered even by a parity function.

The present invention provides a disc array device having a high probability that data can be recovered even when faults of a number exceeding the number of faults correctable by a RAID structure occur.

### Solution to Problem

A storage device according to the present invention includes an accommodation device for accommodating a plurality of detachable recording mediums; a plurality of drive devices, having the recording mediums mounted thereon, for performing data recording and reproduction on or from the recording mediums; a plurality of transport devices for transporting the recording mediums between the accommodation devices and the drive devices; and a control device for controlling an operation of the drive devices and the transport devices. The recording mediums are divided into medium groups each including a prescribed number of recording mediums; each of the medium groups has redundancy by which even when data cannot be reproduced from at least one recording medium belonging thereto, the data can be recovered; the transport devices each can take out a recording medium from a desirable accommodation device among the plurality of accommodation devices and transport the recording medium to a desirable drive device among the plurality of drive devices; the plurality of drive devices include a first drive device and a second drive device; and when the first drive device fails to reproduce data from the recording medium, the transport device transports the recording medium, the data reproduction from which failed, to the second drive device different from the first drive device, and the second drive device attempts to reproduce the data from the recording medium, the data reproduction from which failed.

In an embodiment, on the second drive device, a recording medium belonging to the same medium group as the recording medium which was mounted on the first drive device is not mounted.

In an embodiment, identification information on a drive device having a high level of reproduction performance among the plurality of drive devices is held; and the second drive device matches the identification information.

In an embodiment, the storage device further includes a detection section for detecting the drive device having a high level of reproduction performance from the plurality of drive devices.

In an embodiment, the detection section inspects, with priority, a drive device used for recording parity data at a high frequency or for a long time.

In an embodiment, the storage device further includes a reserve recording medium. When the second drive device successfully reproduces the data from the recording medium transported from the first drive device, all the data of the recording medium transported from the first drive device is copied to the reserve recording medium.

In an embodiment, when the second drive device successfully reproduces the data from the recording medium transported from the first drive device, all the data of the recording medium transported from the first drive device is overwritten on the same recording medium.

In an embodiment, the storage device further includes an inspection section for detecting the quality of a signal reproduced from the recording medium. When the second drive device successfully reproduces the data from the recording medium transported from the first drive device, the inspection section inspects the quality of a signal of recording data of the recording medium transported from the first drive device, and only data having a quality level equal to or lower than a prescribed quality level is overwritten on the same recording medium.

In an embodiment, the storage device further includes a reproduction performance determination section for determining whether or not there is a problem in reproduction performance of the first drive device.

In an embodiment, the storage device further includes a reproduction performance determination section for determining whether or not there is a problem in reproduction performance of the first drive device. When the second drive device successfully reproduces the data from the recording medium transported from the first drive device and the reproduction performance determination section determines that there is no problem in the reproduction performance of the first drive device, all the data of the recording medium transported from the first drive device is copied to the reserve recording medium.

In an embodiment, the reserve recording medium having the data copied thereto is mounted on the first drive device, and recording or reproduction on or from the reserve recording medium is performed.

In an embodiment, the storage device further includes a reproduction performance determination section for determining whether or not there is a problem in reproduction performance of the first drive device. When the second drive device successfully reproduces the data from the recording medium transported from the first drive device and the reproduction performance determination section determines that there is no problem in the reproduction performance of the first drive device, all the data of the recording medium transported from the first drive device is overwritten on the same recording medium.

In an embodiment, the recording medium having the data overwritten thereon is mounted on the first drive device, and recording or reproduction on or from the recording medium is performed.

In an embodiment, the storage device further includes an inspection section for detecting the quality of a signal reproduced from the recording medium. When the number of times parity data is recorded on a replacing area becomes equal to or greater than a prescribed number, the inspection section inspects the quality of a signal of user data paired with the parity data, and records the user data in a replacing area based on a criterion more strict than when the number of times the parity data is recorded on a replacing area is smaller than the prescribed number.

In an embodiment, the storage device further includes a reserve drive device. When the reproduction performance determination section determines that there is a problem in the first drive device, the first drive device is exchanged with the reserve drive device.

In an embodiment, when the reproduction performance of the first drive device is of a level equal to or lower than a prescribed level, the reproduction performance determination section determines that there is a problem in the first drive.

In an embodiment, the storage device further includes a result holding section for holding an inspection result on the reproduction performance of the first drive device at the time when the first drive device started to be used. When the reproduction performance of the first drive device is of a level lower than that of the reproduction performance thereof when the first drive device started to be used by a prescribed degree or greater, the reproduction performance determination section determines that there is a problem in the first drive.

In an embodiment, the storage device further includes a checking section for checking an operating state of the plurality of drive devices. When the reserve drive device is already used, another drive device which is not operated is used instead of the first drive device.

In an embodiment, the storage device further includes a checking section for checking an operating state of the plurality of drive devices. When the reproduction performance determination section determines that there is a problem in the first drive device, another drive device which is not operated is used instead of the first drive device.

### Advantageous Effects of Invention

According to the present invention, when a first drive device fails to reproduce data from a recording medium, the recording medium, the data reproduction from which failed, is transported to a second drive device different from the first drive device, and the second drive device attempts to reproduce the data. Owing to this, even when faults of a number exceeding the number of faults correctable by the RAID structure occur, the probability that the data is recovered can be improved.

### BRIEF DESCRIPTION OF DRAWINGS

FIG. 1 shows a structure of a disc array device.

FIG. 2 shows an example in which data cannot be recovered by the disc array device.

FIG. 3 shows a structure of a disc array device in an embodiment according to the present invention.

FIG. 4 shows an example of RAID structure of recording mediums in the embodiment according to the present invention.

FIG. 5 shows an example of RAID structure of drive devices in the embodiment according to the present invention.

FIG. 6 shows a structure of a disc array device in the embodiment according to the present invention.

FIG. 7 is a flowchart showing an operation of the disc array device in the embodiment according to the present invention.

FIG. 8 is a flowchart showing an operation of the disc array device in the embodiment according to the present invention.

FIG. 9 is a flowchart showing an operation of the disc array device in the embodiment according to the present invention.

FIG. 10 is a flowchart showing an operation of determining a cause of data reproduction error in the embodiment according to the present invention.

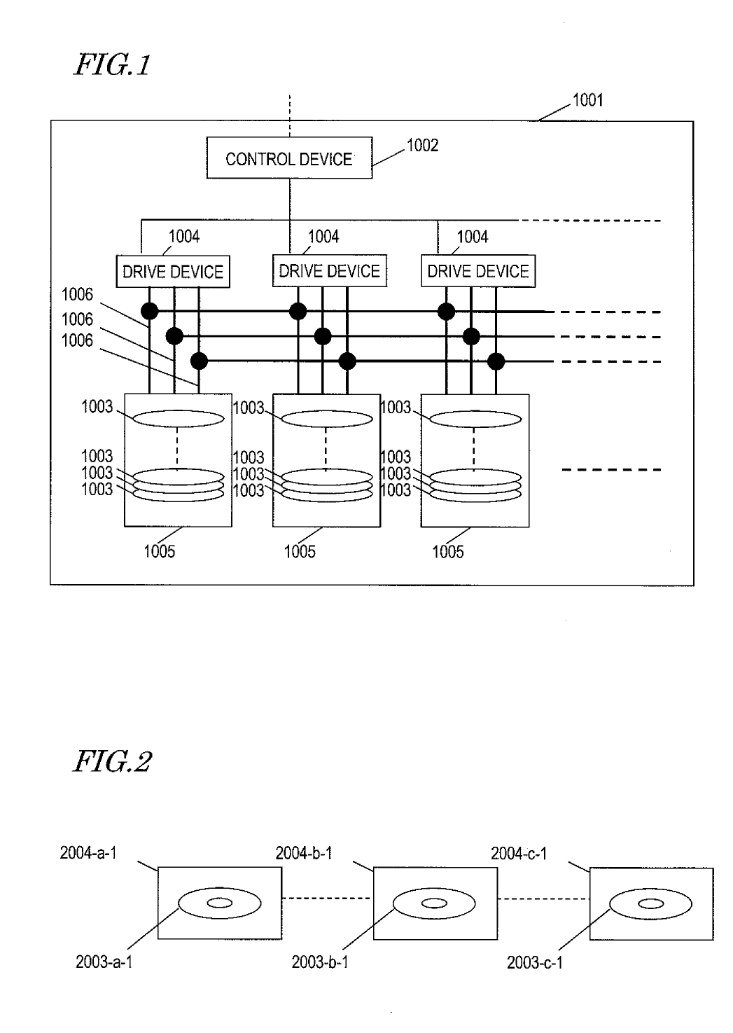

### DESCRIPTION OF EMBODIMENTS

Hereinafter, embodiments of the present invention will be described with reference to the drawings.

### Embodiment 1

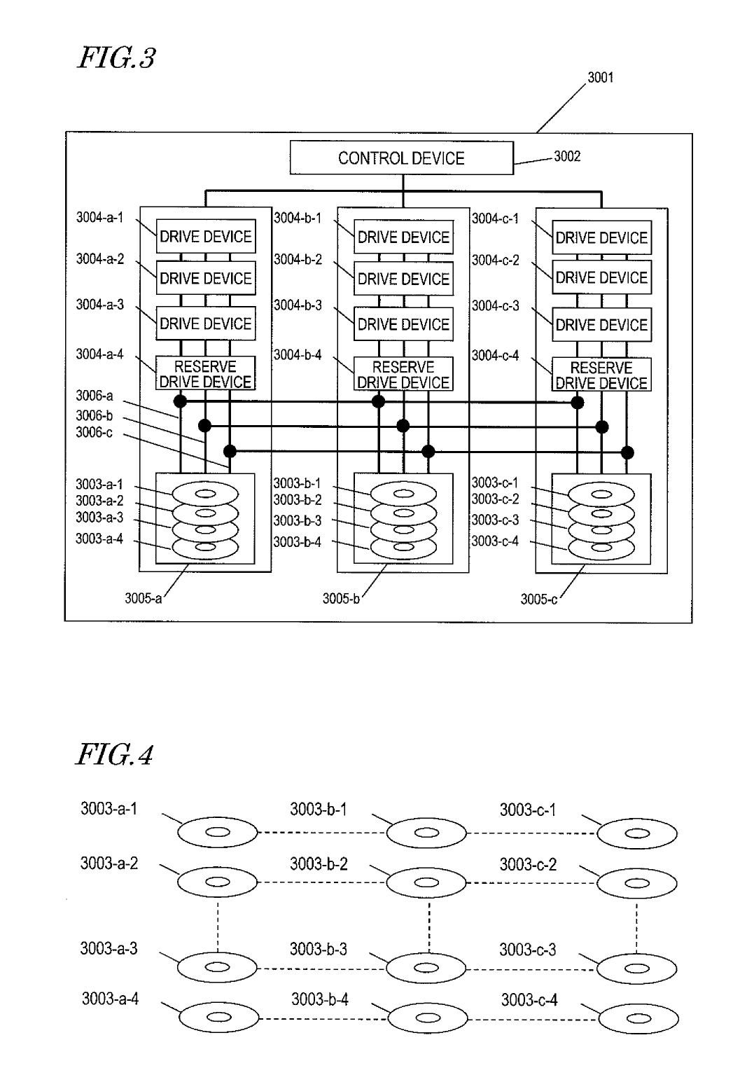

FIG. 3 shows a structure of a disc array device in Embodiment 1 according to the present invention.

A disc array device 3001 includes a control device 3002, a plurality of recording mediums 3003, a plurality of drive devices 3004, a plurality of accommodation devices 3005, and a plurality of transport devices 3006. The disc array device 3001 is a fault-tolerance-type (high reliability-type) storage device having a RAID structure including a plurality of drive devices 3004. In this example, the recording mediums 3003 are optical discs.

The control device 3002 performs a transfer processes between an external processing device (not shown) and any of the drive devices 3004 and controls the transport devices 3006 in compliance with a request from the external processing device. The control device 3002 may be implemented by hardware or software. In each of the accommodation devices 3005, a plurality of recording mediums 3003 are accommodated.

The transport devices 3006 transport the recording mediums 3003 between the accommodation devices 3005 and the drive devices 3004. Each of transport devices 3006 can transport any recording medium 3003 to any drive device 3004.

The recording mediums 3003 are each a recording medium on which data can be recorded. The recording mediums 3003 may each be a rewritable recording medium on which data can be recorded a plurality of times or a write once read many recording medium on which data can be recorded only once.

The drive devices 3004 record data on, or reproduce data from, the recording mediums 3003 transported by the transport devices 3006 and mounted on the drive devices 3004.

The recording mediums 3003 and the drive devices 3004 respectively include reserve recording mediums (3003-a-4, 3003-b-4, 3003-c-4) and reserve drive devices (3004-a-4, 3004-b-4, 3004-c-4) in addition to those which are used in a usual state. The number of the reserve recording mediums 3003 and the number of the reserve drive devices 3004 are not specifically limited. The reserve recording mediums 3003 or the reserve drive devices 3004 may not be provided.

FIG. 4 shows a RAID structure of the recording mediums 3003. The recording mediums 3003 are divided into a group (3003-a-1, 3003-b-1, 3003-c-1), a group (3003-a-2, 3003-b-2, 3003-c-2) and a group (3003-a-3, 3003-b-3, 3003-c-3). Each group forms a RAID4 structure. In this example, one of the three recording mediums in each group is a parity recording medium. Owing to such an arrangement, even when a fault occurs to one of the recording mediums 3003 and data cannot be read therefrom, the data of the recording medium 3003 to which the fault has occurred can be recovered from the remaining two recording mediums 3003 by the parity function.

The groups each forming a RAID structure are not limited to the above. For example, the recording mediums may be divided into a group (3003-a-2, 3003-b-1, 3003-c-1), a group (3003-a-1, 3003-b-3, 3003-c-2) or the like; namely, each group may include any one of the recording mediums in column a, any one of the recording mediums in column b and any one of the recording mediums in column c.

In this embodiment, a group of three recording mediums 3003 forms a RAID structure for easier explanation. Alternatively, a group of four or more recording mediums may form a RAID structure. In addition, each of the accommodation devices 3005 may have four or more recording mediums 3003 accommodated therein.

In this embodiment, RAID4 is adopted, by which one recording medium is a parity recording medium. Alternatively, RAID5 may be adopted, by which the parities are dispersed among a plurality of recording mediums in units called “stripe”. Still alternatively, RAID6 may be adopted, by which the number of parities per stripe is two or more.

In FIG. 4, three reserve recording mediums (3003-a-4, 3003-b-4, 3003-c-4) are provided. The number of the reserve recording mediums are not specifically limited. The reserve recording mediums 3003 may not be provided.

FIG. 5 shows a RAID structure of the drive devices. The drive devices 3004 are divided into a group (3004-a-1, 3004-b-1, 3004-c-1), a group (3004-a-2, 3004-b-2, 3004-c-2) and a group (3004-a-3, 3004-b-3, 3004-c-3). Each group forms a RAID4 structure. Herein, one of the three drive devices in each group will be referred to as a “parity drive device”. In actuality, the RAID structure depends on the recording mediums. Therefore, the parity drive device is the drive device 3004 on which the parity recording medium is mounted. Even when a fault occurs to one of the drive devices 3004 and data cannot be read by the one drive device 3004, the data which is to be reproduced by the drive device 3004 to which the fault occurred can be recovered from the data read by the remaining two drive devices 3004 by the parity function.

The groups each forming a RAID structure is not limited to the above. For example, the drive devices may be divided into a group (3004-a-2, 3004-b-1, 3004-c-1), a group (3004-a-1, 3004-b-3, 3004-c-2) or the like; namely, each group may include any one of the drive devices in column a, any one of the drive devices in column b and any one of the drive devices in column c. Alternatively, the drive devices may be divided into a group (3004-a-1, 3004-a-2, 3004-a-3), a group (3004-b-1, 3004-b-2, 3004-b-3) and a group (3004-c-1, 3004-c-2, 3004-c-3); namely, the drive devices may be divided into a group of the drive devices in column a, a group of the drive devices in column b, and a group of the drive devices in column c.

Still alternatively, one drive device 3004 may sequentially reproduce the data of the recording mediums 3003 forming one RAID structure, without the plurality of drive devices 3004 being used. In this case, data which is reproduced until the data is reproduced from the final recording medium 3003 is saved on an external storage device (not shown).

In this embodiment, a group of three drive devices 3004 forms a RAID structure for easier explanation. Alternatively, a group of four or more drive devices may form a RAID structure.

In FIG. 5, three reserve drive devices (3004-a-4, 3004-b-4, 3004-b-4) are provided. The number of the reserve drive devices are not specifically limited. The reserve drive devices 3004 may not be provided.

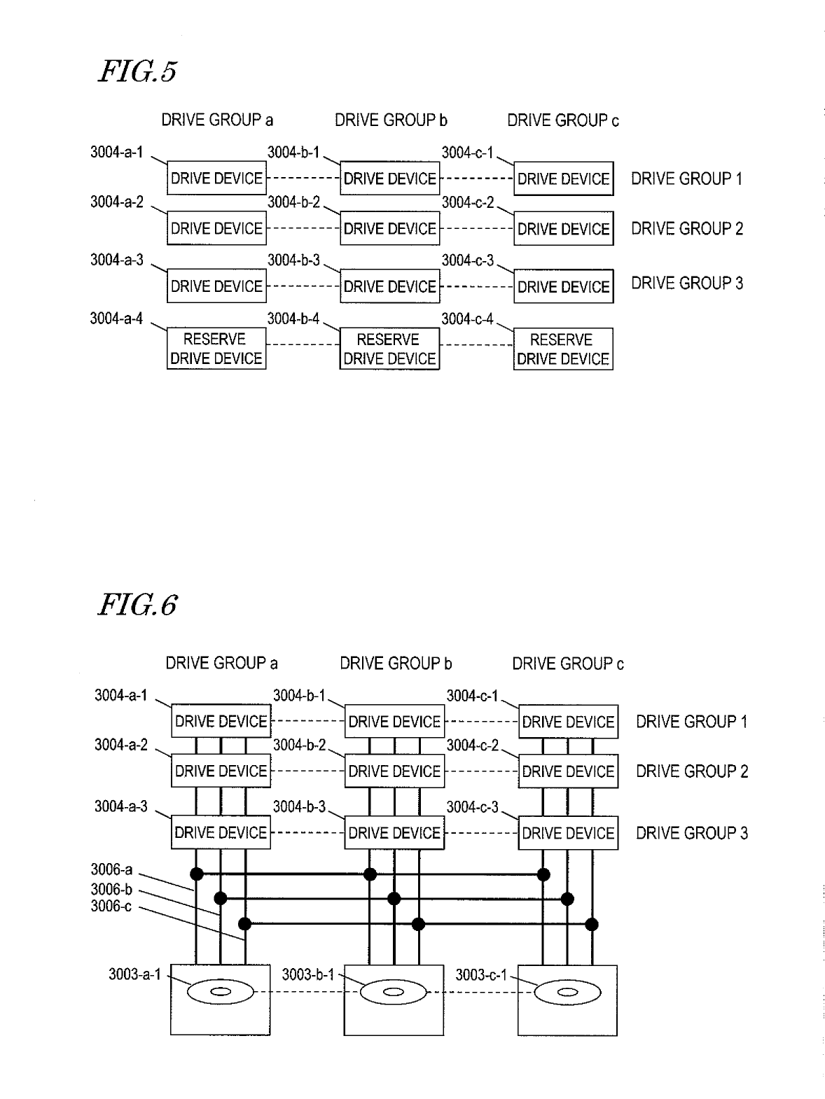

FIG. 6 shows a specific example of structure in Embodiment 1 according to the present invention.

First, a fault which may occur to a recording medium 3003 will be described. A fault which may occur to a recording medium 3003 is, for example, that data cannot be reproduced because of damage such as a large scratch or the like made on a surface of the recording medium 3003, or that data cannot be reproduced because a recording mark disappears due to long-term deterioration. Usually, when such a fault occurs, data cannot be recovered with the recording medium 3003 itself. Therefore, the disc array device 3001 relies on the parity function for recovering the data. Naturally, when a fault exceeding the limit of correction made possible by the parity function occurs to the recording medium 3003, data cannot be recovered. In the meantime, one type of fault which may occur to the recording medium 3003 is that the quality of a signal is gradually lowered due to long-term deterioration. In this case, data recovery may become impossible although the recording mark has not been completely disappeared. Even when a fault exceeding the limit of correction made possible by the parity function occurs to the recording medium 3003, if this type of fault due to the deterioration of the signal quality can be corrected by a certain arrangement, data recovery may be made possible. Namely, the reliability of the disc array device 3001 can be improved.

Now, the performance of a drive device 3004 will be described. The quality of a signal reproduced by a drive device 3004 is made different by performance difference of elements included in the drive device, for example, wavelength of the laser diode, noise level difference, characteristic difference of the transfer path, lens precision of the pickup or the like; or adjustment/control error of the drive device, for example, focus adjustment, tilt adjustment, spherical aberration adjustment, reproduction power control or the like. Such a difference in the quality of the signal reproduced by the drive device 3004 will be referred to as a “reproduction quality difference”. When data is reproduced from the same recording medium 3003 having quality deterioration by a plurality of drive devices 3004, the data can be recovered from a part of the drive devices 3004 and cannot be recovered from the rest of the drive devices 3004 due to the reproduction performance difference among the drive devices 3004.

Now, with reference to FIG. 6, a specific example of operation which is performed utilizing the reproduction performance difference among the drive devices 3004 will be described. As shown in FIG. 5, the drive devices 3004 are divided into drive group 1 (3004-a-1, 3004-b-1, 3004-c-1), drive group 2 (3004-a-2, 3004-b-2, 3004-c-2), and drive group 3 (3004-a-3, 3004-b-3, 3004-c-3). Each drive group can form a RAID structure. The manner of combining the drive drives may be different from the above, as long as one of the drive devices in column a, one of the drive devices in column b, and the drive devices in column c are combined. Alternatively, each group may include the drive devices of the same column among columns a, b and c.

In actuality, the RAID structure is constructed using a group of the recording mediums 3003 (3003-a-1, 3003-b-1, 3003-c-1) forming a RAID structure being transported to any drive device 3004 by any transport device 3006-a, 3006-b or 3006-c and mounted on the drive device 3004.

Now, it is assumed that faults occur to two recording mediums 3003 among the three recording mediums 3003-a-1, 3003-b-1 and 3003-c-1 and thus the data cannot be reproduced from these two recording mediums. When the faults occur to two or more recording mediums 3003, it is attempted to reproduce the data by use of a drive device which is different from the drive devices on which the recording mediums of the medium group (parity group) to which the faults occurred are mounted. For example, the recording medium 3003 is transported by the transport device 3006-a from the drive device 3004-a-1 to the other drive devices 3004-a-2 and 3004-a-3 sequentially and mounted thereon for reproducing the data. The recording medium 3003 is transported by the transport device 3006-b from the drive device 3004-b-1 to the other drive devices 3004-b-2 and 3004-b-3 sequentially and mounted thereon for reproducing the data. The recording medium 3003 is transported by the transport device 3006-c from the drive device 3004-c-1 to the other drive devices 3004-c-2 and 3004-c-3 sequentially and mounted thereon for reproducing the data. In this manner, even when faults occur to two or more recording mediums 3003, the probability that the data is recovered can be improved by use of the reproduction performance difference among the drive devices 3004 in the case where the faults occur because the signal quality is lowered due to the long-term deterioration of the recording mediums.

Alternatively, such data recovery can be made by one drive device 3004 without a plurality of drive devices 3004 being used. The recording mediums 3003 included in the group forming the RAID structure may be sequentially transported to one drive device 3004 by the transport device 3006 for reproducing the data. As long as one drive device 3004 functions normally, data can be reproduced from all the recording mediums 3003 in the group. In this case, data which is reproduced until the reproduction of the data from the final recording medium 3003 is completed is saved on an external storage device (not shown).

Table 2 shows an example of case where data can be recovered in this embodiment. Table 2 shows that the probability that the data is recovered is improved when the structure of the disc array device 3001 is adopted. In Table 2, in the case where faults occur to two among the drive devices 3004 and also to one of the recording mediums 3003, data can be recovered by reproducing data from all the recording mediums 3003 with no fault by the drive device 3004 with no fault. Therefore, “◯” is shown. In Table 2, “Δ” indicates that the probability that the data is recovered is improved by use of the performance difference among the drive devices 3004. Table 2 shows only group 1 of the drive device 3004 (3004-a-1, 3004-b-1, 3004-c-1) for easier explanation.

TABLE 2

| | DRIVE DEVICE | | | | | | |
|---|---|---|---|---|---|---|---|
| | | | | | | | 3004-a-1 |
| RECORDING | | | | 3004-a-1 | 3004-a-1 | 3004-b-1 | 3004-b-1 |
| MEDIUM | 3004-a-1 | 3004-b-1 | 3004-c-1 | 3004-b-1 | 3004-c-1 | 3004-c-1 | 3004-c-1 |
| 3003-a-1 | ◯ | ◯ | ◯ | ◯ | ◯ | ◯ | X |
| 3003-b-1 | ◯ | ◯ | ◯ | ◯ | ◯ | ◯ | X |
| 3003-c-1 | ◯ | ◯ | ◯ | ◯ | ◯ | ◯ | X |
| 3003-a-1 | Δ | Δ | Δ | Δ | Δ | Δ | X |
| 3003-b-1 | | | | | | | |
| 3003-a-1 | Δ | Δ | Δ | Δ | Δ | Δ | X |
| 3003-c-1 | | | | | | | |
| 3003-a-1 | Δ | Δ | Δ | Δ | Δ | Δ | X |
| 3003-b-1 | | | | | | | |
| 3003-c-1 | | | | | | | |

As shown in Table 1, data recovery is impossible with the structure of the disc array shown in FIG. 2 in many cases. By contrast, data recovery is made possible even with only one drive device 3004 by the structure according to the present invention. As shown in Table 2, the probability that the data is recovered can be improved in many cases by use of the reproduction performance difference among the drive devices 3004.

With the structure of the disc array 3001 according to the present invention, three recording mediums 3003 and nine drive devices 3004 are used. Alternatively, four or more recording mediums 3003 and ten or more drive devices 3004 may be used.

As described above, the disc array device in this embodiment includes a plurality of detachable recording mediums, plurality of accommodation devices for accommodating the recording mediums, a plurality of drive devices, each having a recording medium mounted thereon, for performing recording and reproducing on and from the recording medium, a plurality of transport devices for transporting the recording mediums between the accommodation devices and the drive devices, and a control device for controlling the plurality of drive devices and the plurality of transport devices.

In such a structure, the recording mediums 3003 are divided into medium groups each including a prescribed number of recording mediums 3003. Each medium group has redundancy by which that even when data cannot be reproduced from at least one recording medium belonging thereto, the data can be recovered. The transport devices each can take out the recording medium from any accommodation device and transport the recording medium to any drive device.

In the disc array device in this embodiment, when one drive device fails to reproduce data from a recording medium, the transport device transports the recording medium, the data reproduction from which failed, to a drive device different from the drive device which failed to reproduce the data, and the different drive device attempts to reproduce the data.

Owing to such a structure, even when a fault exceeding the limit of correction made possible by the redundancy provided by the RAID structure occurs, data reproduction is made possible. For example, even when faults occur to two or more recording mediums, the probability that the data is recovered can be improved by use of the reproduction performance difference among the drive devices 3004 in the case where the faults occur because the signal quality is lowered due to the long-term deterioration of the recording mediums.

Information on the performance of the drive devices 3004 may be held on a storage memory (not shown) in the control device so that reproduction is performed by the drive device 3004 having the highest level of performance with priority.

The reproduction performance of the drive devices 3004 is also deteriorated because, for example, the characteristics of elements included therein are lowered by the long-term deterioration, or the adjustment/control error of the devices is increased due to the distortion or positional shift of components caused by the stress applied for many years. Therefore, the performance of the drive devices 3004 may be inspected periodically and the results may be held on the storage memory in the control device 3002.

Namely, the disc array device in this embodiment may hold identification information on the drive device having a high level of reproduction performance among the plurality of drive devices. In this case, the recording medium mounted on the drive device which failed to reproduce the data may be transported to the drive device matching the identification information so that the latter drive device can attempt to reproduce the data.

The recording medium 3003 used for the inspection may be determined by reproducing data already recorded on each recording medium 3003 by each drive device 3004, or a recording medium 3003 for performance inspection may be provided separately.

Indexes used for comparing the drive devices 3004 regarding the reproduction performance are, for example, degree of modulation, beta, jitter, error rate, and an index indicating the signal quality correlated to the error rate of binarization result obtained when a PRML signal processing system is used.

In the case where the data reproduction is made possible by exchanging the drive device 3004 as described above, it is considered that the quality of the data recorded on the recording medium 3003 is deteriorated. Specifically by referring to the result of the performance inspection made on the drive device 3004 which is held on the storage memory in the control device 3002 as described above, it can be determined whether the failure in the data reproduction is caused by the reproduction performance of the drive device 3004 or by the quality of the signal recorded on the recording medium 3003.

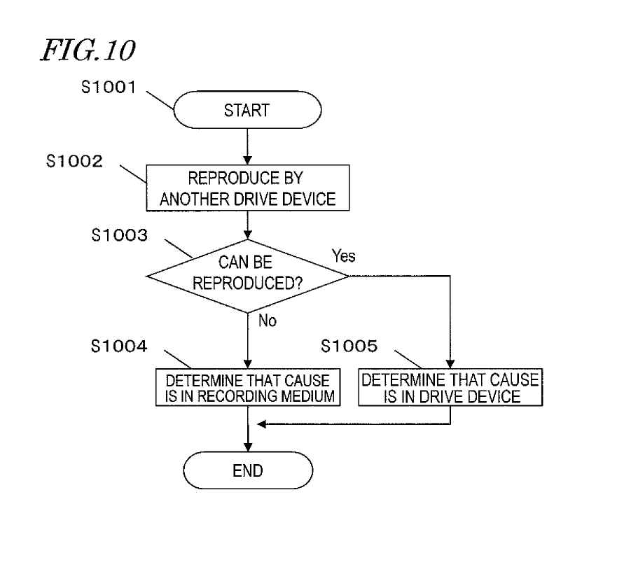

Now, a specific method for determination will be described with reference to a flowchart in FIG. 10.

It is determined whether the cause of the failure is the deterioration of the drive device or the deterioration of the recording medium as follows. After the process is started (S1001), the recording medium, the data reproduction from which failed, is transported to another drive device 3004, and the another drive device 3004 attempts to reproduce the data (S1002). Thus, it is determined whether or not the data can be reproduced (S1003). When the data cannot be reproduced, this indicates that the data cannot be reproduced by any of the other (plurality of) drive devices 3004. In this case, it is determined that the cause of the failure is the deterioration of the recording medium (S1004). By contrast, when the data can be reproduced, it is determined that the cause of the failure is the deterioration of the drive device (S1005).

When it is determined that the cause of the failure is the deterioration of the drive device, the performance of the drive device may be inspected by use of, for example, the recording medium 3003 for inspection. In this case, it can be determined with more certainty that the cause of the failure is the deterioration of the drive device. When the inspection result indicates that there is no problem in the drive device, it can be determined that the data reproduction failed because of another cause such as an external impact or the like. Alternatively, before it is attempted to reproduce the data from the recording medium by the another drive device in S1002, the performance of each drive device 3004 may be inspected to determine whether or not the drive device 3004 of interest is deteriorated. As a result, it can be determined whether the cause of the failure is the deterioration of the recording medium or the deterioration of the drive device.

The procedure for determining whether the cause of the failure is the deterioration of the drive device or the deterioration of the recording medium is not limited to the example shown in FIG. 10. Any other procedure is usable as long as substantially the same effect is provided.

When, as a result, it is determined that the problem is in the signal quality of the recording medium 3003, it is desirable to replace the recording medium 3003, namely, to re-record all the data on the recording medium 3003 which is not used or on a reserve recording medium 3003.

Namely, the disc array device in this embodiment may further include a reserve recording medium. In this case, when the data is successfully reproduced from the recording medium transported from the drive device which failed to reproduce the data, all the data of the recording medium transported from the drive device which failed to reproduce the data may be copied to the reserve recording medium.

Alternatively, the disc array device in this embodiment may further include a reserve recording medium. The drive device may further include an inspection section for detecting the quality of a signal reproduced from the recording medium, a result holding section for holding the result of the inspection performed by the inspection section on each drive device, and a reproduction performance determination section for determining whether or not there is a problem in the reproduction performance of the drive device which failed to reproduce the data by referring to the result held in the result holding section. The control device 3002 may have functions of the inspection section, the result holding section and the reproduction performance determination section.

In this case, in the disc array device in this embodiment, when the data is successfully reproduced from the recording medium transported from the drive device which failed to reproduce the data and the reproduction performance determination section determines that there is no problem in the reproduction performance of the drive device, all the data of the recording medium may be copied to the reserve recording medium.

The reserve recording medium having the data copied thereto may be mounted on the drive device which failed to reproduce the data and it may be attempted to perform data recording or reproduction on or from the reserve medium. If the cause of the failure in the data reproduction is in the recording medium, the drive device which failed to reproduce the data can perform normal recording or reproduction when the reserve recording medium with no fault is mounted thereon. Thus, the drive device can be used again.

In this case, the reserve recording medium 3003 has exactly the same data as the recording medium 3003 from which the data was copied, namely, has the data copied as it is including the file positions and sector information (management information). Therefore, the disc array device can be recovered to the original state with no updating on the file system or the like in the other recording mediums 3003.

In the case where the recording medium is of a rewritable type, it is possible that data cannot be reproduced because the size of the recording mark is changed, for example, decreased due to the long-term deterioration. The signal quality is recovered by overwriting the reproduced data at the same position. Owing to the recording medium thus improved, the reliability of the disc array device can be improved.

Namely, in the disc array in this embodiment, when the data is successfully reproduced from the recording medium transported from the drive device which failed to reproduce the data, all the data of the recording medium transported from the drive device which failed to reproduce the data may be overwritten on the same recording medium.

The disc array device in this embodiment may include an inspection section for detecting the quality of a signal reproduced from the recording medium, a result holding section for holding the result of the inspection performed by the inspection section on each drive device, and a reproduction performance determination section for determining whether or not there is a problem in the reproduction performance of the drive device which failed to reproduce the data by referring to the result held in the result holding section. In this case, in the disc array device in this embodiment, when the data is successfully reproduced from the recording medium transported from the drive device which failed to reproduce the data and the reproduction performance determination section determines that there is no problem in the reproduction performance of the disc drive, all the data of the recording medium may be overwritten on the same recording medium.

The recording medium having the data overwritten thereon may be mounted on the drive device which failed to reproduce the data and it may be attempted to perform recording or reproduction on or from this reserve medium. If the cause of the failure in the data reproduction is the deterioration of the recorded data, the drive device which failed to reproduce the data can perform normal recording or reproduction when the post-overwriting recording medium is mounted thereon. Thus, the drive device can be used again.

Indexes used for checking the signal quality of the recording medium are, for example, degree of modulation, beta, jitter, error rate, and an index indicating the signal quality correlated to the error rate of binarization result obtained when a PRML signal processing system is used.

Regarding a recording medium 3003 using a phenomenon called “phase change” as the recording principle, one of causes of deterioration of the recording medium 3003 is cycle deterioration, which is caused by data being rewritten a large number of times. A recording film to which phase change is caused contains a metal compound as a composition. The metal compound is heated to a temperature exceeding the crystallization point or the melting point, and then is cooled. In accordance with the rate of cooling, the metal compound is made crystalline or amorphous. Such a temperature change causes deterioration similar to metal fatigue to the recording film. As described above, it is common to RAID4, RAID5 and RAID6 that the recording mediums have an area where user data is recorded and an area where parity data is recorded. The parity data is rewritten a larger number of times than the user data. In a general RAID4 or RAID5 structure, the ratio of the region of the user data is significantly higher than the ratio of the region of the parity data; for example, one piece of parity data is provided for eight pieces of user data. Now, the eight pieces of user data are labeled as D1, D2, D3, . . . D8; and one piece of parity data is labeled as P. Each time when any of the user data pieces D1 through D8 is rewritten, the parity data P needs to be rewritten. Therefore, the number of times the parity data is rewritten becomes large.

Table 3 shows an example of relationship between the number of times the user data is rewritten and the number of times the parity data is rewritten in RAID4. Table 3 shows the number of times the parity data P is rewritten when the user data pieces D1 through D8 are each rewritten once while the data of the RAID group is rewritten eight times. In the example of Table 3, each of the user data pieces D1 through D8 is rewritten once, whereas the parity data is rewritten eight times.

TABLE 3

| NUMBER OF | | | | | | | | | |
|---|---|---|---|---|---|---|---|---|---|
| TIMES OF REWRITE | DATA | | | | | | | | |
| OF RAID GROUP | D1 | D2 | D3 | D4 | D5 | D6 | D7 | D8 | P |
| 1 | 1 | 0 | 0 | 0 | 0 | 0 | 0 | 0 | 1 |
| 2 | 0 | 1 | 0 | 0 | 0 | 0 | 0 | 0 | 2 |
| 3 | 0 | 0 | 1 | 0 | 0 | 0 | 0 | 0 | 3 |
| 4 | 0 | 0 | 0 | 1 | 0 | 0 | 0 | 0 | 4 |
| 5 | 0 | 0 | 0 | 0 | 1 | 0 | 0 | 0 | 5 |
| 6 | 0 | 0 | 0 | 0 | 0 | 1 | 0 | 0 | 6 |
| 7 | 0 | 0 | 0 | 0 | 0 | 0 | 1 | 0 | 7 |
| 8 | 0 | 0 | 0 | 0 | 0 | 0 | 0 | 1 | 8 |

Utilizing the fact that the number of times the parity data P is rewritten is large, the degree of deterioration of the parity data P can be monitored. Thus, the degree of deterioration of the user data pieces D1 through D8 can be estimated. Usually, a recording medium 3003 includes a spare area which can replace the deteriorated area. When the number of times the parity data P is deteriorated and recorded in a replacing area becomes equal to or larger than a prescribed number of times (e.g., half of the ratio between the user data and the parity data), the user data belonging to the same stripe is inspected. The threshold level for the signal quality is made somewhat strict (e.g., the threshold level for the error rate is made half of the usual level) so that the user data is recorded in a replacing area slightly earlier than actually necessary. By such an arrangement, a situation where the plurality of pieces of user data belonging to the same stripe become non-reproduceable at the same time can be avoided. The threshold level in this case is more strict than in the case where the number of times the parity data P is recorded in a replacing area is smaller than the prescribed number of times.

The disc array device in this embodiment may further include an inspection section for detecting the quality of a signal reproduced from the recording medium. In this case, when the number of times the parity data provided for redundancy is recorded in a replacing area exceeds a prescribed number of times, the inspection section may inspect the signal quality of the user data paired with the parity data so that the user data can be recorded in a replacing area based on a threshold level more strict than usual. Instead of recording the user data in the replacing area earlier than actually necessary, the recording medium 3003 may be exchanged.

As described above, the drive devices 3004 are also subjected to the long-term deterioration. For example, a spindle motor for rotating the recording medium 3003, a traverse motor for moving a pickup for reading or writing a signal from or on the recording medium 3003, and components for supporting the spindle motor and the traverse motor are deteriorated more easily as the number of times these elements are moved is larger. As described above, in the case of RAID4, a parity disc on which only the parity data is recorded is provided. A parity drive device on which the parity disc is mounted frequently is provided. The parity drive device is accessed a large number of times. For example, when an instruction to rewrite D2 to D2′ is received from an external processing device (not shown), parity data P′ to be newly generated can be found by either of the following two methods:

P′=D1+D2′+D3+D4+D5+D6+D7+D8

or

P′=D2+D2′+P

where the operator of an exclusive or is “+”. Obviously, the latter method requires a small amount of data to be read and a small amount of data to be calculated, and thus provides a higher level of performance. Namely, it is common to use the latter method for finding the parity data P′.

For rewriting the user data pieces D1 through D8, the parity data P is accessed. Therefore, the parity data is accessed a large number of times. Namely, the parity drive device is also accessed a large number of times. Thus, the spindle motor, the traverse motor and related components are deteriorated faster.

Based on this fact, it is desirable that at a periodical performance inspection of the drive devices 3004, the parity drive device should be inspected with priority. The drive device(s) to be inspected may be selected based on the number of times the parity recording medium is mounted on each drive device or the length of time of such mounting.

Namely, the disc array device in this embodiment may include a detection section for detecting a drive device having a high level of reproduction performance from the plurality of drive devices. In this case, the detection section may inspect, with priority, a drive device used for recording the parity data at a high frequency or for a long time.

As described above, the reliability of the disc array device may be decreased due to the performance deterioration of the drive device 3004 although there is no problem in the signal quality of the recording medium 3003. Thus, when the reproduction performance of a drive device 3004 provided as a result of the above-mentioned periodical inspection is of a level equal to or lower than a prescribed level, the drive device 3004 is automatically exchanged with a reserve drive device 3004. By such an arrangement, the reliability of the disc array device 3001 can be improved.

Namely, the disc array device in this embodiment may include a reserve drive device. The disc array device in this embodiment may further include an inspection section for detecting the quality of a signal reproduced from the recording medium, a result holding section for holding the result of the inspection performed by the inspection section on each drive device, and a reproduction performance determination section for determining whether or not there is a problem in the reproduction performance of the drive device which failed to reproduce the data by referring to the result held in the result holding section. In this case, in the disc array device in this embodiment, when the reproduction performance determination section determines that there is a problem in the drive device which failed to reproduce the data, the drive device which failed to reproduce the data may be exchanged with the reserve drive device.

In the case where the reserve drive device 3004 is not provided or is already used, the control device 3002 searches for a drive devices 3004 which is not reproducing data from the other drive devices 3004 included in the disc array device 3001, and the drive device 3004 thus found is used instead of the drive device 3004 to which the fault occurred until the drive device 3004 to which the fault occurred is exchanged with a normal drive device 3004. Thus, the reliability or even the availability of the disc array device 3001 can be improved.

Namely, the disc array device in this embodiment may further include a reserve drive device and a checking section for checking an operating state of the drive devices. In this case, when the reserve drive device is already used, a drive device which is not operated may be used instead of the drive device which failed to reproduce the data.

The disc array device in this embodiment may further include an inspection section for detecting the quality of a signal reproduced from the recording medium, a result holding section for holding the result of the inspection performed by the inspection section on each drive device, and a reproduction performance determination section for determining whether or not there is a problem in the reproduction performance of the drive device which failed to reproduce the data by referring to the result held in the result holding section. In this case, in the disc array device in this embodiment, when the reproduction performance determination section determines that there is a problem in the drive device which failed to reproduce the data, a drive device which is not operated may be used instead of the drive device which failed to reproduce the data.

The criterion by which whether or not the reproduction performance of the drive device 3004 is deteriorated may be whether or not the reproduction performance of the drive device 3004 is of a level equal to or lower than a prescribed level as described above.

Namely, in the disc array device in this embodiment, when the reproduction performance of the drive device which failed to reproduce the data is of a level equal to or lower than the prescribed level, the reproduction performance determination section may determine that there is a problem in the drive device.

Alternatively, when the reproduction performance difference between the drive device 3004 of interest and the drive device 3004 having the highest level of performance has a value equal to or larger than a prescribed value, the reproduction performance determination section may determine that the reproduction performance of the drive device 3004 of interest is deteriorated.

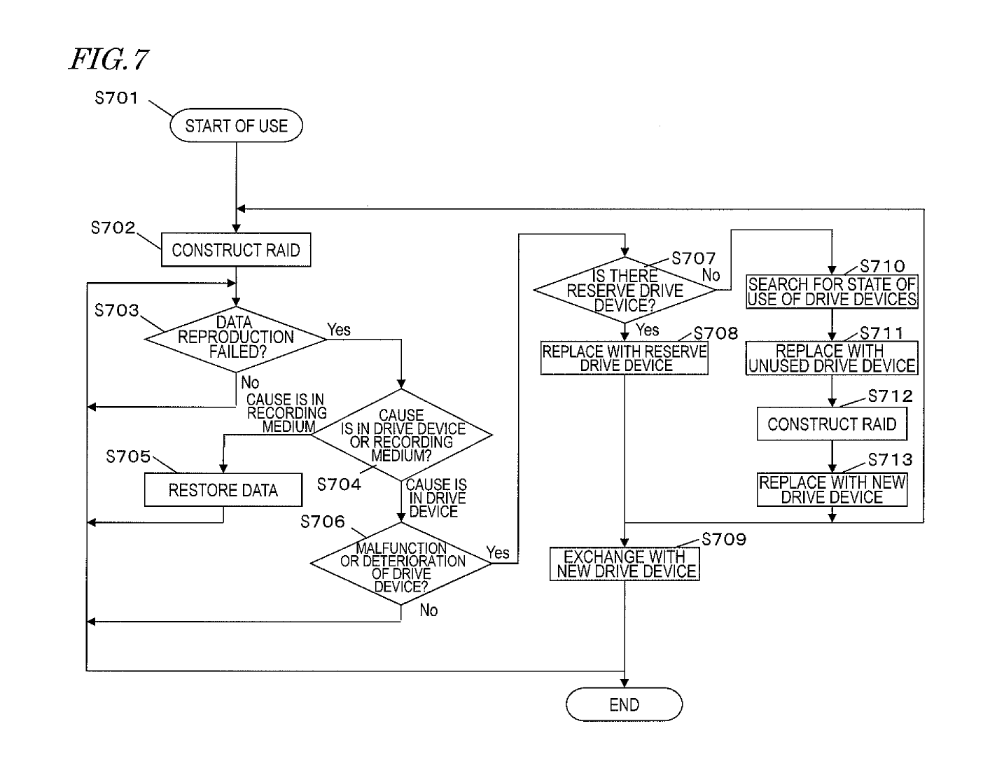

With reference to a flowchart in FIG. 7, an example of operation of the disc array device 3001 will be described.

First, the disc array device starts to be used (S701). Next, a RAID structure is constructed (S702), and an operation of recording, reproduction or the like is performed by the disc array device. The RAID structure may be a RAID4, RAID5, RAID6 or any other RAID structure. There is no limitation on the number of the drive devices 3004 included in the RAID structure. In addition to the drive devices 3004 actually included in the RAID structure, a reserve drive device can be provided. It is detected whether or not data reproduction failed while the disc array device was used (S703). When the data reproduction did not fail, the operation is continued. By contrast, when the data reproduction failed, it is determined whether the cause of the failure is in the drive device or in the recording medium. The determination can be made by the method described above with reference to FIG. 10. When it is determined that the cause of the failure is in the recording medium in S704, the data is restored (S705). For restoring the data of the recording medium, all the data may be recorded on a recording medium 3003 which is not in use or a reserve recording medium 3003 so that the recording medium 3003 having the problem is replaced therewith, or only a part of the data deteriorated in a certain area may be recorded in an unused area or in an area provided as a replacing area of the same recording medium 3003. When the recording medium, the data reproduction from which failed, is transported to another drive device and the data can be reproduced by this drive device by use of the performance difference among the drive devices, the data is restored by use such reproduced data. When the data cannot be reproduced even by any other drive device 3004, data recovered by the parity function of RAID can be used.

By contrast, when it is determined that the cause of the failure is in the drive device, it is determined whether or not the drive device malfunctions or is deteriorated (S706). When it is determined that the drive device neither malfunctions nor is deteriorated, it is determined that the data reproduction failed because of an influence of a factor other than factors related to the drive device, for example, an external impact or the like, and thus the operation is continued. By contrast, when it is determined that the drive device 3004 malfunctions or is deteriorated, the drive device 3004 is exchanged. First, it is checked whether or not there is a reserve drive device (S707). When there is a reserve drive device, the drive device which malfunctions or is deteriorated is replaced with the reserve drive device (S708), and a RAID structure is re-constructed (S702). Then, the drive device which malfunctions or is deteriorated is exchanged with a new drive device not included in the disc array device (S709), and the operation of the disc array device is continued. The operation in S708 is an operation of transporting the recording medium 3003 mounted on the drive device which malfunctions or is deteriorated to the reserve drive device. The operation in S709 is an operation of exchanging the drive device which malfunctions or is deteriorated with a new drive device not included in the disc array device.

By contrast, when the reserve disc device is already used and is not available, or when no reserve disc device is provided originally, a state of use of the drive devices 3004 in the disc array device is checked (S710), and the drive device which malfunctions or is deteriorated is replaced with an unused drive device (S711). The operation in S711 is an operation of transporting the recording medium 3003 mounted on the drive device which malfunctions or is deteriorated to the unused drive device. A RAID structure is re-constructed using the drive device 3004 newly adopted in S711 (S712). In S712, the RAID structure is re-constructed using the unused drive device as a RAID structure to be provided temporarily until the drive device which malfunctions or is deteriorated is exchanged with a new drive device (S713). Therefore, when such a drive device temporarily used is used by the RAID structure originally constructed before the operation in S713 is carried out, the operation in S710 through S712 is repeated. When there is no unused drive device, the recording medium 3003 mounted on the drive device which malfunctions or is deteriorated may be transported to another drive device 3004 in the RAID structure to which the drive device which malfunctions or is deteriorated belonged, so that the data is reproduced by the another drive device 3004. In this case, one drive device 3004 reproduces data from a plurality of recording mediums 3003. Thus, the reproduced data is saved on an external storage device (not shown). After the exchange to the new drive device is made in S713, a RAID structure is re-constructed in S702.

The operation shown in the flowchart in FIG. 7 is merely an example. The present invention is not limited to this. Any other operation which provides substantially the same effect is usable.

Information on the reproduction performance of the drive device 3004 at the time when the drive device 3004 started to be used may be held on the storage memory in the control device 3002. When the level of the reproduction performance of the drive device 3004 provided as a result of the periodical inspection is lower than the level of the reproduction performance held on the storage memory by a prescribed degree or greater, it may be determined that the reproduction performance of the drive device 3004 is deteriorated. Namely, in the disc array device in this embodiment, when the level of the reproduction performance of the drive device which failed to reproduce the data is lower than the level of the reproduction performance thereof at the time when the drive device started to be used by a prescribed degree or greater, the reproduction performance determination section may determine that there is a problem in the drive device.

The disc array device 3001 may be structured as follows. Based on the information on the performance of the drive device 3004 held on the storage memory in the control device 3002 or the reproduction performance of the drive device 3004 inspected by use of the inspection recording medium for inspection at the time when the drive device 3004 started to be used, drive devices 3004 having a higher level of performance are selected from an optional number of drive devices 3004 to construct a RAID structure. The drive devices 3004 which are not selected are used as reserve drive devices 3004. By constructing a RAID structure using the drive devices 3004 having a higher level of performance with priority as described above, the reliability of the disc array device 3001 can be further improved.

The determination on whether or not the reproduction performance of the drive device 3004 is deteriorated may be performed based on the following criterion. When the level of the reproduction performance of a drive device 3004 included in the RAID structure becomes lower than the level of the reproduction performance of a reserve drive device 3004, it may be determined that the drive device 3004 included in the RAID structure is deteriorated and may be exchanged with the reserve drive device 3004. When the drive device 3004 determined as having the reproduction performance thereof deteriorated and exchanged with the reserve drive device 3004 still has the reproduction performance of a level equal to or higher than a prescribed level, such a drive device 3004 may be held as a reserve drive device 3004. Alternatively, the determination on whether or not the reproduction performance of a drive device 3004 included in the RAID structure is deteriorated and needs to be exchanged with another drive device 3004 may be performed based on the reproduction performance of a drive device 3004 having the highest level of reproduction performance among the reserve drive devices 3004. In the case where it is determined whether or not a drive device 3004 included in the RAID structure needs to be exchanged with another drive device 3004 based on the comparison with the reproduction performance of a reserve device 3004 having the highest level of reproduction performance among the reserve drive devices 3004 as described above, the RAID structure includes, with priority, drive devices 3004 having a high level of characteristics among the drive devices 3004 included in the disc array device 3001. Thus, the reliability of the disc array device 3001 can be kept high.

When the performance of a drive device 3004 is determined as being of a level equal to or lower than a prescribed level, it is requested that the drive device 3004 should be exchanged with a new disc drive 3004 not included in the disc drive 3004. The request of exchange may be indicated by, for example, blinking of an LED or display of a liquid crystal display screen.

When a new drive device 3004 is incorporated into the disc array device 3001 as a result of the exchange, the RAID structure may be re-constructed as follows. The performance of the newly incorporated drive device 3004 is inspected. Based on the result of the inspection, drive devices 3004 having a high level of reproduction performance are used with priority for the RAID structure.

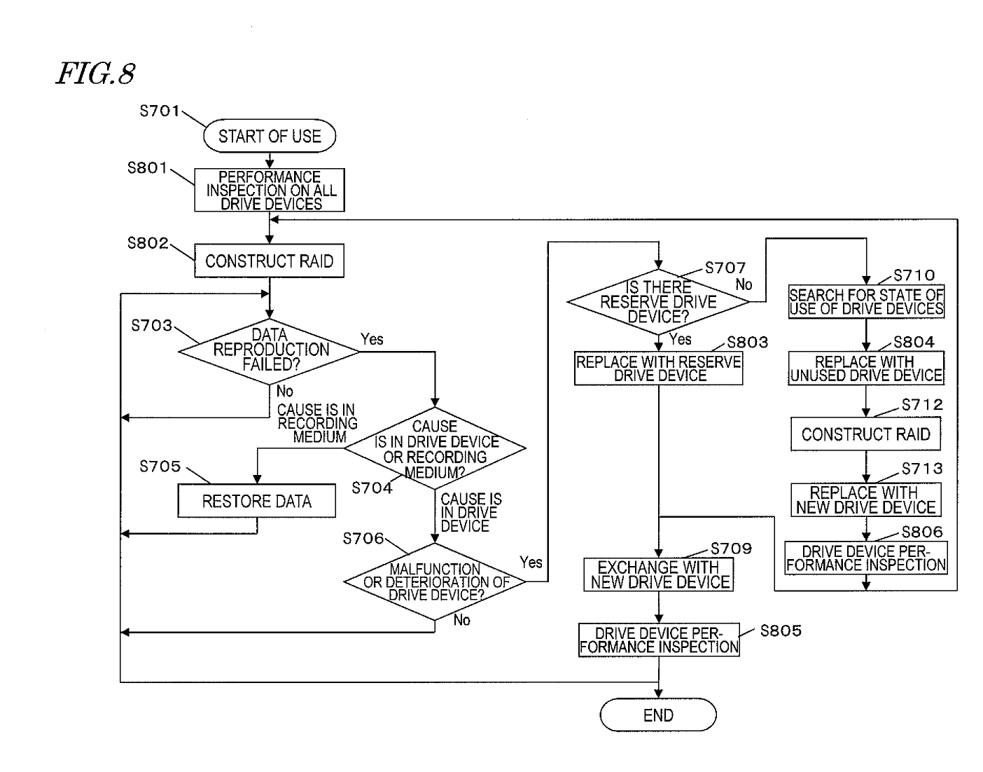

Now, with respect to a flowchart in FIG. 8, an example of operation of the disc array device will be described. Steps substantially the same as those in FIG. 7 will bear identical reference numerals thereto, and the same operations will not be repeatedly described.

Referring to FIG. 8, after the disc array starts to be used (S701), all the drive devices are inspected (S801). A RAID structure is constructed using drive devices 3004 having a high level of performance with priority, and drive devices 3004 having a lower level of performance among all the drive devices are used as reserve drive devices (S802). After this, substantially the same operations are performed until S707, which will not be described repeatedly.

When it is determined in S707 that there is a reserve drive device, the drive device which malfunctions or is deteriorated is replaced with the reserve drive device (S803), and then a RAID structure is re-constructed in S802. When there are a plurality of drive devices which are usable for the replacement, the drive device having the highest level of performance is used for the replacement. Then, the drive device which malfunctions or is deteriorated is exchanged with a new drive device (S709). The performance of the new drive device is inspected (S805), and then the operation is continued. The new drive device is used as a reserve drive device, but the performance thereof is inspected in order to check the rank thereof among the reserve drive devices and determine which of the reserve devices is to be used the next time when a drive device needs to be exchanged.

By contrast, when there is no reserve drive device, the state of use of the drive devices is checked in S710, and the drive device which malfunctions or is deteriorated is replaced with an unused drive device (S804). When there are a plurality of unused drive devices, the drive device having the highest level of performance is used for the replacement. After S712 and S713, the performance of the new drive is inspected (S806). Based on the result obtained in S806, a RAID structure is re-constructed (S802).

Owing to the operation shown in FIG. 8, when the drive device which malfunctions or is deteriorated is exchanged with a reserve drive device, the reserve drive device having the highest level of performance among the reserve devices can be selected for the replacement.

The operation shown in the flowchart in FIG. 8 is merely an example. The present invention is not limited to this. Any other operation which provides substantially the same effect is usable.

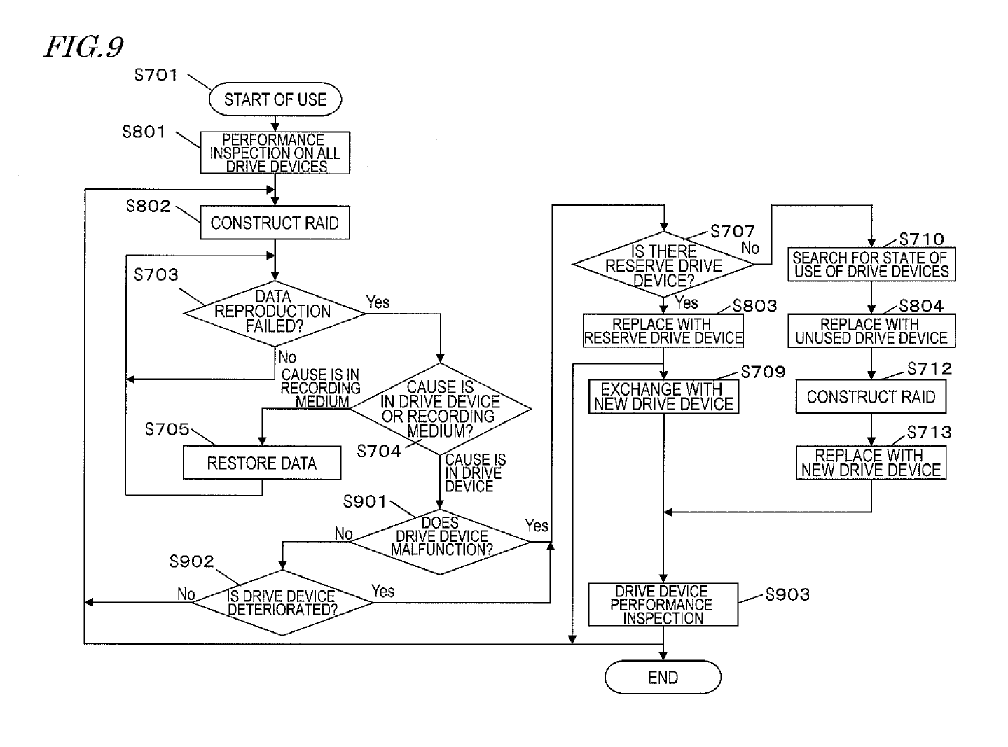

The disc array device may be operated as shown in a flowchart in FIG. 9. Steps substantially the same as those in FIG. 7 and FIG. 8 will bear identical reference numerals thereto, and the same operations will not be repeatedly described.

Referring to FIG. 9, the operations are substantially the same as those in FIG. 8 until S704 and thus will not be described repeatedly. When it is determined in S704 that the cause of the failure is in the drive device, it is determined whether or not the drive device malfunctions (S901). When the drive device does not malfunction, it is determined whether or not the drive device is deteriorated (S902). In S902, it is determined whether or not the drive device is deteriorated. In S902, when the level of the performance of the drive device is lower than the level obtained by the inspection in S801 or in S903 described later by a prescribed degree or greater, or when a value equal to or greater than an optionally defined value is obtained, the drive device is determined as being deteriorated. Therefore, even when the drive device is determined as not being deteriorated, such a determination may not necessarily indicate that the drive device is not deteriorated at all. The determination merely indicates that the drive device is not deteriorated to the level matching the above-mentioned criterion, but it is possible that the drive device is deteriorated to a certain degree. In this case, the level of performance of the drive device of interest included in the RAID structure may be lower than the level of performance of a reserve drive device. Therefore, when the performance of the drive device is determined as not being deteriorated, a RAID structure is re-constructed in S802.

When the drive device is determined as malfunctioning in S901 or when the drive device is determined as being deteriorated in S902, it is determined whether or not there is a reserve drive device in S707. After this, the operations until S703 or S713 are substantially the same as those in FIG. 8 and thus will not be described repeatedly. After S703 or S713, the performance of the new drive device is inspected (S903), and a RAID structure is re-constructed in S802.

Owing to the operation shown in FIG. 9, the RAID structure always includes drive devices 3004 having a high level of performance.

After the exchange with the new drive device is made in S709 or S713, all the drive devices may be inspected in S801. In this case, the drive devices 3004 other than the drive device 3004 used for the data reproduction can be inspected regarding a change of performance due to the long-term deterioration. Therefore, the RAID structure can be constructed using the drive devices 3004 found as having a higher level of performance by the latest inspection.

The operation shown in the flowchart in FIG. 9 is merely an example. The present invention is not limited to this. Any other operation which provides substantially the same effect is usable.

In the case of a medium including a plurality of recording layers, the degree of deterioration of the recorded data due to the long-term deterioration varies among the recording layers. Therefore, regarding the layers other than the layer from which the data was not reproduced successfully, the signal quality may be detected so that data is overwritten only when the signal quality is of a level equal to or lower than a prescribed level.

The recorded data is deteriorated in accordance with the time elapsing from the time of recording. Therefore, only the data which was recorded before the data reproduced for the determination on deterioration was recorded may be overwritten. Alternatively, the signal quality may detected so that data is overwritten only when the signal quality is of a level equal to or lower than a prescribed level.

Namely, the disc array device in this embodiment may further include an inspection section for detecting the quality of a signal reproduced from a recording medium. In this case, in the disc array device in this embodiment, when the data is successfully reproduced from the recording medium transported from the drive device which failed to reproduce the data, the recording quality of prescribed data recorded on the recording medium may be inspected and only the data of a level equal to or lower than a prescribed level may be overwritten.

In the above description, the recording medium is assumed to be as an optical disc, but according to the present invention, the recording medium is not limited to an optical disc. The recording medium may be, for example, a semiconductor memory such as a flash memory or the like, or a magnetic tape. The present invention is applicable to a storage device for constructing a RAID structure using a plurality of detachable recording mediums.

### INDUSTRIAL APPLICABILITY

A disc array device according to the present invention includes a control device for reproducing data from a recording medium by use of reproduction performance difference among drive devices, and thus can improve fault tolerance (reliability) and is usable for an archive system or the like.

### REFERENCE SIGNS LIST

1001, 3001 Disc array device
1002, 3002 Control device
1003, 2003-a-1, 2003-b-1, 2003-c-1, 3003-a-1 through 3003-a-4, 3003-b-1 through 3003-b-4, 3003-c-1 through 3003-c-4 Recording medium
1004, 2004-a-1, 2004-b-1, 2004-c-1, 3004-a-1 through 3004-a-4, 3004-b-1 through 3004-b-4, 3004-c-1 through 3004-c-4 Drive device
1005, 3005-a, 3005-b, 3005-c Accommodation device
1006, 3006-a, 3006-b, 3006-b Transport device

1. A storage device, comprising:
an accommodation device for accommodating a plurality of detachable recording mediums;
a plurality of drive devices, having the recording mediums mounted thereon, for performing data recording and reproduction on or from the recording mediums;
a plurality of transport devices for transporting the recording mediums between the accommodation devices and the drive devices; and
a control device for controlling an operation of the drive devices and the transport devices;
wherein:
the recording mediums are divided into medium groups each including a prescribed number of recording mediums;
each of the medium groups has redundancy by which even when data cannot be reproduced from at least one recording medium belonging thereto, the data can be recovered;
the transport devices each can take out a recording medium from a desirable accommodation device among the plurality of accommodation devices and transport the recording medium to a desirable drive device among the plurality of drive devices;
the plurality of drive devices include a first drive device and a second drive device; and
when the first drive device fails to reproduce data from the recording medium, the transport device transports the recording medium, the data reproduction from which failed, to the second drive device different from the first drive device, and the second drive device attempts to reproduce the data from the recording medium, the data reproduction from which failed.

2. The storage device of claim 1, wherein on the second drive device, a recording medium belonging to the same medium group as the recording medium which was mounted on the first drive device is not mounted.

3. The storage device of claim 1, wherein:
identification information on a drive device having a high level of reproduction performance among the plurality of drive devices is held; and
the second drive device matches the identification information.

4. The storage device of claim 3, further comprising a detection section for detecting the drive device having a high level of reproduction performance from the plurality of drive devices.

5. The storage device of claim 4, wherein the detection section inspects, with priority, a drive device used for recording parity data at a high frequency or for a long time.

6. The storage device of claim 1, further comprising a reserve recording medium;
wherein when the second drive device successfully reproduces the data from the recording medium transported from the first drive device, all the data of the recording medium transported from the first drive device is copied to the reserve recording medium.

7. The storage device of claim 1, wherein when the second drive device successfully reproduces the data from the recording medium transported from the first drive device, all the data of the recording medium transported from the first drive device is overwritten on the same recording medium.

8. The storage device of claim 1, further comprising an inspection section for detecting the quality of a signal reproduced from the recording medium;
wherein when the second drive device successfully reproduces the data from the recording medium transported from the first drive device, the inspection section inspects the quality of a signal of recording data of the recording medium transported from the first drive device, and only data having a quality level equal to or lower than a prescribed quality level is overwritten on the same recording medium.

9. The storage device of claim 1, further comprising a reproduction performance determination section for determining whether or not there is a problem in reproduction performance of the first drive device.

10. The storage device of claim 6, further comprising a reproduction performance determination section for determining whether or not there is a problem in reproduction performance of the first drive device;
wherein when the second drive device successfully reproduces the data from the recording medium transported from the first drive device and the reproduction performance determination section determines that there is no problem in the reproduction performance of the first drive device, all the data of the recording medium transported from the first drive device is copied to the reserve recording medium.

11. The storage device of claim 6, wherein the reserve recording medium having the data copied thereto is mounted on the first drive device, and recording or reproduction on or from the reserve recording medium is performed.

12. The storage device of claim 1, further comprising a reproduction performance determination section for determining whether or not there is a problem in reproduction performance of the first drive device;
wherein when the second drive device successfully reproduces the data from the recording medium transported from the first drive device and the reproduction performance determination section determines that there is no problem in the reproduction performance of the first drive device, all the data of the recording medium transported from the first drive device is overwritten on the same recording medium.

13. The storage device of claim 7, wherein the recording medium having the data overwritten thereon is mounted on the first drive device, and recording or reproduction on or from the recording medium is performed.

14. The storage device of claim 1, further comprising an inspection section for detecting the quality of a signal reproduced from the recording medium;
wherein when the number of times parity data is recorded on a replacing area becomes equal to or greater than a prescribed number, the inspection section inspects the quality of a signal of user data paired with the parity data, and records the user data in a replacing area based on a criterion more strict than when the number of times the parity data is recorded on a replacing area is smaller than the prescribed number.

15. The storage device of claim 9, further comprising a reserve drive device;
wherein when the reproduction performance determination section determines that there is a problem in the first drive device, the first drive device is exchanged with the reserve drive device.

16. The storage device of claim 9, wherein when the reproduction performance of the first drive device is of a level equal to or lower than a prescribed level, the reproduction performance determination section determines that there is a problem in the first drive.

17. The storage device of claim 9, further comprising a result holding section for holding an inspection result on the reproduction performance of the first drive device at the time when the first drive device started to be used;
wherein when the reproduction performance of the first drive device is of a level lower than that of the reproduction performance thereof when the first drive device started to be used by a prescribed degree or greater, the reproduction performance determination section determines that there is a problem in the first drive.

18. The storage device of claim 15, further comprising a checking section for checking an operating state of the plurality of drive devices;
wherein when the reserve drive device is already used, another drive device which is not operated is used instead of the first drive device.

19. The storage device of claim 9, further comprising a checking section for checking an operating state of the plurality of drive devices;
wherein when the reproduction performance determination section determines that there is a problem in the first drive device, another drive device which is not operated is used
